(19) United States
(12) Patent Application Publication
(10) Pub. No.: US 2025/0338880 A1
(43) Pub. Date: Nov. 6, 2025

(54) PRECOOKED PASTA, METHOD FOR PRODUCING SAME, AND SEASONING LIQUID FOR PASTA

(71) Applicants: SHINGEN FOODS CO., LTD., Yamanashi, Koushu-shi (JP); TABLE STOCK CO., LTD., Yamanashi, Koushu-shi (JP)

(72) Inventor: Satoshi SHIRASAWA, Yamanashi (JP)

(73) Assignees: SHINGEN FOODS CO., LTD., Yamanashi, Koushu-shi (JP); TABLE STOCK CO., LTD., Yamanashi, Koushu-shi (JP)

(21) Appl. No.: 18/729,898

(22) PCT Filed: Jan. 20, 2023
(86) PCT No.: PCT/JP2023/001619

§ 371 Date: Jan. 15, 2025

(30) Foreign Application Priority Data
Jan. 21, 2022 (JP) 2022-007617

(51) Int. Cl. A23L 7/109; A23L 27/00; A23L 29/30

(52) U.S. Cl. CPC A23L 7/111; A23L 27/00; A23L 29/35

(57) ABSTRACT

The purpose of the present invention is to provide: a precooked pasta for which separation of the seasoning liquid is suppressed and pasta hardness (chewiness) is maintained; a method for producing the same; and a seasoning liquid for pasta. The aforementioned is achieved by a precooked pasta comprising a seasoning liquid and pasta, wherein: the seasoning liquid includes dextrin in a proportion of 1.0 mass % to 15.0 mass % and includes a water-soluble solid component; and the Brix value of the precooked pasta is 33.5% to 45.5%.

### TECHNICAL FIELD

This invention relates to a cooked pasta in which separation of a seasoning liquid is suppressed and a firmness (crunchiness) of pasta is maintained.

### BACKGROUND ART

Pasta, in which wheat is used generally as a raw material, has a dense internal structure and a unique texture having smooth mouthfeel and an appropriate firmness (crunchiness). Therefore, in processed foods using pasta that has been cooked, maintaining the unique and inherent texture of pasta is important element to enhance its commercial value.

In products intended for long-term storage, such as retort pouch foods, it is particularly difficult to maintain appropriate firmness (crunchiness) in pasta because it is subjected to high-temperature heat and pressure processing.

For example, Patent Document 1 describes a method of heat sterilizing a container packed with noodles that have been pre-heated and frozen and a seasoning liquid containing a specific amount of starch degradation product having a specific DE value, as a means of preventing the noodles from falling apart in a container-packed processed food with noodles.

According to the method described in Patent Document 1, it is possible to produce the container-packed processed food with noodles that prevents the noodles from falling apart and maintains an appropriate firmness even after being stored for a long period of time.

### CITATION LIST

### Patent Documents

Patent Document 1: JP 6923986 B

### SUMMARY OF THE INVENTION

### Problems to be Solved by the Invention

However, the method described in Patent Document 1 has the problem that when the seasoning liquid is cream based, the seasoning liquid separates, resulting in a poor appearance.

Therefore, for the problems to be solved, the present invention is to provide a cooked pasta and its producing method, wherein the cooked pasta can prevent a separation of the seasoning liquid and maintain the firmness (crunchiness) of the pasta.

### Means of Solving the Problems

The inventor was faced with the problem that the method described in Patent Document 1 causes separation of the seasoning liquid when the seasoning liquid is cream based, i.e., when oils/fats containing milk ingredients or dairy products are used as raw materials for the seasoning liquid. The inventor has concluded that the cause of the separation of the seasoning liquid is large amounts of starch degradation products in the seasoning liquid in the method described in Patent Document 1. This is thought to be because when starch degradation products (e.g., dextrin) are contained in large amounts in the seasoning liquid, the starch degradation products take up water contained in the milk ingredients, and the proteins that have lost water in the milk ingredients solidify and appear to be separated. To solve the above problem, the inventor focused on a Brix value which is an index of amount of soluble solid ingredient, and reviewed the ingredients of the seasoning liquid, and repeated trial and error. Finally, the inventor found that when the Brix value of the starch degradation products solution is higher than that of the milk ingredients solution of the same weight, water migrates into the starch degradation products solution, while when the Brix value of the milk ingredients solution is equal to or higher than that of the starch degradation products solution of the same weight, water does not migrate into the starch degradation solution. By adjusting the Brix value of the cooked pasta to 33.5% to 45.5%, the separation of the seasoning liquid can be suppressed even if the seasoning liquid is cream based, and the pasta can maintain its firmness. Surprisingly, it was also found that the firmness of the pasta was maintained over a long period of time by adjusting the Brix value of the cooked pasta, even when the cooked pasta was packed in containers for long-term storage. More surprisingly, it was also found that the cooked pasta with the adjusted Brix value maintained its firmness while eating, even though a certain period of time had elapsed. Moreover, it was found that not only cream-base seasoning liquid, but also non-cream-based seasoning liquid maintained the firmness of the pasta for a certain period after being mixed with the pasta by adjusting the Brix value of the seasoning liquid to 30.0% to 50.0%. The invention has been completed based on such successful examples and findings.

Therefore, according to one embodiment of the present invention, the following [1] to [9] are provided:
[1] A cooked pasta comprising a seasoning liquid and pasta,
   wherein the seasoning liquid contains dextrin at a ratio of 1.0% by mass to 15.0% by mass and a soluble solid ingredient, and
   a Brix value of the cooked pasta is 33.5% to 45.5%.
[2] The cooked pasta according to [1], wherein the soluble solid ingredient is at least one of an oil, a dairy product and a processed tomato product.
[3] The cooked pasta according to any one of [1] to [2], wherein the seasoning liquid is contained at a ratio of 80 parts by mass to 200 parts by mass with respect to 100 parts by mass of the pasta.
[4] The cooked pasta according to any one of [1] to [3], wherein the cooked pasta is packed in a retort container.
[5] A method of producing a cooked pasta, comprising;
   a step of obtaining the cooked pasta by mixing pasta with a seasoning liquid containing dextrin at a ratio of 1.0% by mass to 15.0% by mass and a soluble solid ingredient, and
   wherein the cooked pasta has a Brix value of 33.5% to 45.5%.
[6] The method according to [5], wherein the soluble solid ingredient is at least one of an oil, a dairy product and a processed tomato product.
[7] The method according to any one of [5] to [6], wherein the seasoning liquid is contained at a ratio of 80 part by mass to 200 parts by mass with respect to 100 parts by mass of the pasta.
[8] A seasoning liquid for pasta comprising dextrin at a ratio of 1.0% by mass to 15.0% by mass and a soluble solid ingredient,
   wherein the seasoning liquid has a Brix value of 30.0% to 50.0%.
[9] The seasoning liquid according to [8], wherein the soluble solid ingredient is at least one of an oil, a dairy product and a processed tomato product.

### Effects of the Invention

According to a cooked pasta according to one embodiment of the present invention, the separation of the seasoning liquid is suppressed, and the firmness of the pasta is maintained.

### DESCRIPTION OF EMBODIMENTS

While a cooked pasta according to one embodiment of the present invention will now be described in further details, the scope of the present invention is not limited to what is described in this section; rather, the present invention may take various other forms to the extent that its objective is achieved.

Unless otherwise specified, each term herein is used in the sense in which it is commonly used by those skilled in the art and should not be construed as having an unduly restrictive meaning.

The term “amount (content)” is synonymous herein with concentration and means the ratio (e.g., mass percent) of the amount (e.g., mass) of an ingredient to the total amount (e.g., volume) of a seasoning liquid.

The term “comprising (containing)” means that elements other than those explicitly stated as included can be added (synonymous with “at least including”), but includes “consisting of” and “consisting essentially of”. That is, “comprising (containing)” can mean including the explicitly stated elements and any one or more elements of any one or more kinds, consisting of the explicitly stated elements, or consisting essentially of the explicitly stated elements. Elements include ingredients, processes, conditions, parameters, and other limitations.

The wording “to” for indicating a range of values is intended to include values preceding and following the wording; for example, “0% to 100%” means a range from 0% or more and 100% or less. The terms “more than” and “less than” used herein means the lower and upper limits without including a value following the term, respectively. For example, “more than 1” means a value beyond 1, and “less than 100” means a value below 100.

The number of digits in the integer value matches the number of digits in the significant digits. For example, a significant digit of 1 is one digit and a significant digit of 10 is two digits. Also, the number of decimal digits after the decimal point is equal to the number of significant digits. For example, a significant digit of 0.1 is one digit and a significant digit of 0.10 is two digits.

### Cooked Past

A cooked pasta according to one embodiment of the present invention is a cooked pasta containing a seasoning liquid and pasta, wherein the seasoning liquid contains dextrin at a ratio of 1.0% to 15.0% by mass and a soluble solid ingredient, and a Brix value of the cooked pasta is 33.5% to 45.5%.

### Brix Value

The cooked pasta according to one embodiment of the present invention has a Brix value of 33.5% to 45.5%, preferably 37.0% to 43.0%. By the Brix value of the cooked pasta is between 33.5% and 45.5%, it is possible to maintain the firmness (crunchiness) of the pasta. If the Brix value is excessive, the viscosity of the seasoning liquid increases, which deteriorates the entanglement of the pasta and the seasoning liquid, prevents the pasta and the seasoning liquid from being completely mixed together, and prevents uniform water transfer throughout the pasta, resulting in uneven pasta firmness, a poor texture, and an uneven taste. On the other hand, if the Brix value is too low, the pasta may not maintain its firmness (crunchiness).

In the present invention, the Brix value refers to an indication of a refractometer for sugar at a sample temperature of 20° C.

In the present invention, a sample of the Brix value of the cooked pasta is prepared from a pasta, a seasoning liquid, and other ingredients in the cooked pasta, all of which are blended in a food processor to form a paste. Specifically, the Brix value of the cooked pasta is the value measured by the example method described below.

The Brix value can be adjusted mainly by adjusting the amount of dextrin and/or soluble solid ingredients in the seasoning liquid as described below.

### Seasoning Liquid

The seasoning liquid contains dextrin at a ratio of 1.0% by mass to 15.0% by mass and a soluble solid ingredient.

In particular, even when the seasoning liquid is cream based, i.e., when an oil containing milk ingredient or dairy product described below are used as a soluble solid ingredient in the seasoning liquid, separation is suppressed by the dextrin amount of 1.0% by mass to 15.0% by mass.

Here, the cream-based seasoning liquid refers to emulsified seasoning liquid prepared with milk ingredients. In the present invention, the cream-based seasoning liquids include not only cream sauces in the narrow sense of the term, in which fresh cream is added to béchamel sauce, but also so-called cream sauce-styles that are similar to cream sauces in the narrow sense.

### Dextrin

Dextrin is contained in the seasoning liquid at a ratio of 1.0% by mass to 15.0% by mass, preferably at a ratio of 5.0% by mass to 13.0% by mass. Specifically, when the dextrin amount is 1.0% by mass to 15.0% by mass of the seasoning liquid, separation of the seasoning liquid is suppressed even if the seasoning liquid is cream based.

If the dextrin amount is excessive, separation of the seasoning liquid may occur if the seasoning liquid is cream based.

The dextrin can be used without particular limitation as long as it can be used in general for foods. Examples of dextrins include dextrin having a DE value of about 4 to 10 and maltodextrin having a DE value of about 10 to 18. Further, the dextrin can be used alone or in combination of two or more. The Brix value of dextrin is about 9.5% when 10 g of dextrin is dissolved in 100 g of water.

### Soluble Solid Ingredient

In the present invention, the soluble solid ingredient is an ingredient other than the dextrin that adjusts the Brix value. The soluble solid ingredient can be used without limitation as long as they can be used in foods in general, and one type alone or a combination of two or more types can be used.

The soluble solid ingredient includes, for example, an oil, a dairy product, a processed tomato product, salt, sugar, and a starch syrup. Among these, it is preferable to use at least one of an oil, a dairy product, and a processed tomato product from the viewpoint of not causing extreme changes in taste even when a considerable amount of soluble solid ingredients is added as the seasoning liquid for pasta.

The amount of soluble solid ingredient is not limited as long as the Brix value of the cooked pasta is adjusted to 33.5% by mass to 45.5% by mass but is preferably 5.0% by mass to 50.0% by mass with respect to the seasoning liquid, more preferably 10.0% by mass to 36.0% by mass.

### Oil

As an oil that can be used in foods in general can be used without any particular limitation, and one type alone or a combination of two or more types can be used. In particular, a powdered oil/fat and an emulsified oil/fat are preferably used as an oil from the viewpoint of ease of the Brix value adjustment. Among these, the powdered oil/fat is preferred from the viewpoint of ease of handling.

The powdered oil/fat is defined as an oil/fat powdered with excipients such as carbohydrates and proteins. The powdered oil/fat is usually water soluble and have a powdered form at room temperature (about 1° C. to 30° C.).

In the present invention, the powdered oil/fat used as ingredients for the seasoning liquid may contain milk ingredients (e.g., milk protein, full-fat milk powder, skimmed milk powder, whey powder, buttermilk powder, etc.) as excipients.

As for the powdered oil/fat, the Brix value of about 6% to 9% is preferred when 10 g of the powdered oil/fat is dissolved in 90 g of water.

The emulsified oil/fat is defined as an oil/fat that have been given hydrophilic properties by adding an emulsifier to a raw material oil/fat such as a solid and liquid oil/fat.

For example, rapeseed oil, soybean oil, corn oil, safflower oil, sunflower oil, cottonseed oil, sesame oil, rice oil, palm oil, palm olein, olive oil, peanut oil, coconut oil, palm oil, perill oil, milk fat, beef fat, lard, fish oil, etc. are examples of the raw material oil/fat for the emulsified oil/fat.

As for the emulsified oil/fat, the Brix value of about 30% to 70% is preferred.

For example, in the case of the powdered oil/fat, the amount of the oil/fat is preferably 5.0% by mass to 40.0% by mass with respect to the seasoning liquid, more preferably 10.0% by mass to 36.0% by mass, and in the case of the solid or liquid oil/fat, the amount the oil/fat is 1.0% by mass to 10.0% by mass with respect to the seasoning liquid, more preferably 3.0% by mass to 7.0% by mass. If the oil/fat amount is excessive, the taste may be greasy and cloying due to the high oil amount.

### Dairy Product

As for a dairy product, any product that can be used in foods in general as a product of milk ingredients can be used without any particular limitation, and one type alone or a combination of two or more types can be used.

The dairy product includes, for example, milk, cream, whey, cheese, yogurt, butter, condensed milk, powdered milk (whole milk powder and skimmed milk powder), and casein. Among these, the powdered milk is preferred for ease of handling.

The dairy product has the Brix value of about 30% to 70% for liquids, and the Brix value of about 7.0% to 9.5% for powders, when 10 g of the powder is dissolved in 90 g of water.

The amount of dairy product, for example, is 1.0% by mass to 40.0% by mass with respect to the seasoning liquid, more preferably 3.0% by mass to 35.0% by mass.

### Processed Tomato Product

As for the processed tomato product, any raw material derived from tomatoes that can be used in foods in general may be used without any particular limitation, and one type alone or a combination of two or more types may be used.

The processed tomato product includes, for example, tomato puree, tomato paste, and tomato ketchup.

The processed tomato product has the Brix value of 30% to 33% is preferred.

The amount of the processed tomato product, for example, is 1.0% by mass to 30.0% by mass with respect to the seasoning liquid, more preferably 3.0% by mass to 20.0% by mass.

### Other Components

In addition to the dextrin and soluble solid ingredient, other components may be contained in the seasoning liquid. The aforementioned other components are not particularly limited, but are, for example, water, seasonings, yeast extract, meat extract (chicken extract, pork extract, beef extract, fish meat extract, etc.), fruit juice. (apple juice, etc.), vegetable juice, spices (ginger, capsicum, pepper, basil, oregano, etc.), coloring agents, amino acid-based seasonings, nucleic acid-based seasonings, organic acid-based seasonings, flavor enhancing additives, flavors and the like, and they can be used either individually or in combination of two or more.

The Brix value of the seasoning liquid is adjusted so that the Brix value of the cooked pasta is between 33.5% and 45.5%, specifically between 30.0% and 50.0%, more preferably between 35.0% and 45.0%. By being the Brix value of 30.0% to 50.0% in the seasoning liquid, the Brix value of the cooked pasta as the final product is 33.5% to 45.5%, and the firmness (crunchiness) of the pasta can be maintained.

While the method of preparing the seasoning liquid is not particularly limited, it can be prepared by weighing, mixing or blending, and heating as necessary the dextrin and soluble solid ingredients and other ingredients.

### Pasta

The pasta is specifically pasta in an edible state that has been heat-treated from uncooked pasta (i.e., fresh or dried pasta). The pasta can be short pasta, long pasta, or any other shape (e.g., plate). The short pasta includes: maccaroni (macaroni), elbo, penne, rigatoni (grooved tubular), maniche (thick tubular), cappelletti, lumaconi, luote (wheel-shaped), conchiglie (shell-shaped), cavatappi (spiral-shaped tubular pasta), risoni (rice-shaped), semini (seed-shape), twist, fridge (also called spirale or curl (spiral shape)), farfalle (butterfly shape), orecchiette (earlobe shape), etc. The long pasta such as spaghetti, spaghettini, fedelini, cappellini, linguine, fettuccine, tagliatelle, capelli d'angelo, pappardelle, vermicelli, etc., and other shapes of pasta include, for example, lasagna.

The heat treatment method for the fresh or dried pasta is not limited, but heat treatment methods of the normal pasta can be employed without any particular restrictions, such as boiling heat treatment methods and steam heat treatment methods.

The pasta may be used as the fresh or dried pasta that has been heat-treated, or the frozen pasta (heat-treated pasta that has been frozen) that has been thawed.

While the moisture value (water content) of the pasta is not particularly limited, for example, in the case that the type of the pasta is fresh pasta, it is about 30% to about 40%, preferably about 32% to about 35%, and in the case that the type of the pasta is dried pasta, it is about 10% to about 15%.

In addition, the moisture value of the pasta is not particularly limited but is preferably about 45% to about 60%.

### Other Ingredients

The cooked pasta according to one embodiment of the present invention, other ingredients may be contained along with the seasoning liquid and pasta. Other ingredients include, but are not limited to, for example, meat, seafood, vegetables, fruits, soybean products and the like. Further, these other ingredients may be cooked together with the seasoning liquid. While the amount of the aforementioned other ingredients is appropriately determined depending on the type of product or the like, and is not particularly limited, it is, for example, 5% by mass to 15% by mass with respect to the total amount of the seasoning liquid and pasta.

The combining ratio of the seasoning liquid and the pasta can be appropriately determined according to the type of pasta and the type of product, and the like. For example, it is preferable that the seasoning liquid be contained at a ratio of 80 parts by mass to 200 parts by mass with respect to 100 parts by mass of pasta (heat treated pasta), more preferably at a ratio of 80 parts by mass to 150 parts by mass, even more preferably at a ratio of 90 parts by mass to 130 parts by mass.

Specifically, the cooked pasta according to one embodiment of the present invention is about 70 g to 150 g of the pasta (heat-treated pasta), 80 g to 225 g of the seasoning liquid, and 18 g to 50 g of other ingredients, with respect to a total amount of about 150 g to 420 g per meal (per person).

### Cooked Pasta in Container-Packed

The cooked pasta according to one embodiment of the present invention may be packed in heat-sterilized containers, specifically in retort containers or cans, for long-term storage.

According to the cooked pasta according to one embodiment of the present invention, the pasta maintains its firmness (crunchiness) over a long period of time, even when it is packed in containers and heat sterilized.

The container used in packing is not particularly limited as long as it is made of a material and made from a shape that can withstand the heat sterilization treatment and can be sealed. Examples of them include packaging containers such as pouches, sachets, bottles, trays, cans, and bottles made of, for example, metal such as aluminum, plastic such as PET and PTP, one-layer or stacked-layer (laminated) film, glass, and the like. In particular, when a retort container is used, specifically, examples of the containers include a container manufactured using stacked-layer (laminated) film provided with a heat-weldable resin layer made of an olefin resin such as polypropylene or polyethylene on its inside, and with a layer made of, for example, a resin having a high gas barrier property such as polyester or polyamide and/or aluminum foil on its outside. Retort containers for microwave heating include containers with steam vents.

### Method of Producing

A method of producing the cooked pasta according to one embodiment of the present invention includes the process of obtaining cooked pasta by mixing pasta (heat-treated pasta) with a seasoning liquid containing dextrin at a ratio of 1.0% by mass to 15.0% by mass and a soluble solid ingredient, wherein the cooked pasta has a Brix value of 33.5% to 45.5%.

In the method of producing the cooked pasta according to one embodiment of the present invention, the method of mixing the seasoning liquid and the heat-treated pasta is not limited but includes the method of dressing the heat-treated pasta with the seasoning liquid and the method of putting the heat-treated pasta into the seasoning liquid and further heat-cooking it.

In the method of producing the cooked pasta according to one embodiment of the present invention, when the cooked pasta is packed in containers, it further includes the process of filling a predetermined container with the seasoning liquid, pasta (heat-treated pasta), and other ingredients as needed, sealing it, and heat sterilizing it.

The heat sterilization treatment method is not particularly limited, and the heat sterilization treatment method usually used in food production can be adopted.

The temperature and time for the heat sterilization treatment can be appropriately determined according to the type of product, the filling amount, the type of container, and the like. For example, when the heat sterilization treatment is a retort sterilization treatment, it is carried out under pressure at 100° C. to 130° C., preferably about 125° C. for 6 minutes to 15 minutes, preferably 6 minutes to 9 minutes, having a F value, an index of the sterilization strength, of 4 or more, preferably 5 to 10. Known devices and methods for retort sterilization can be used. For example, in the case of heat sterilization treatment other than retort sterilization, such as heat sterilization treatment for canning and bottling, the heat sterilization treatment can be performed at 121° C. to 135° C. for 5 minutes to 30 minutes.

The cooked pasta in containers-packed according to one embodiment of the present invention can be stored for a long period of time at room temperature (15° C. to 25° C.). When eating the cooked pasta, it can be heated by boiling in boiling water for 3 minutes to 10 minutes, for example, or by heating in a microwave oven.

As described above, according to the cooked pasta according to one embodiment of the present invention, separation of the seasoning liquid is suppressed and the firmness (crunchiness) of the pasta is maintained. The reason why this effect is obtained might not be obvious, but it is considered to be based on the following principle. It should be noted that such principle does not limit the technical scope of the present invention. Briefly, the amount of dextrin in the seasoning liquid is reduced in the cooked pasta according to one embodiment of the present invention compared to the cooked noodles described in Patent Document 1 in order to inhibit separation of the seasoning liquid. However, if the dextrin amount is reduced, the pasta will not maintain its firmness (crunchiness). Therefore, by using the soluble solid ingredient other than the dextrin to adjust the Brix value of the final product, it is realized that the pasta maintains an appropriate firmness (crunchiness). The reason for maintaining pasta firmness (crunchiness) is that as the Brix value of the cooked pasta increases, the free water decreases and overall water transfer also decreases, resulting in less water transfer from the seasoning liquid to the pasta. Therefore, it is believed that the pasta does not absorb excess water and maintains its firmness (crunchiness). The same principle is thought to apply not only to the container-packed cooked pasta that has been stored for a long period of time, but also after a certain time has elapsed during eating.

Hereinafter, the present invention will be described in more detail with reference to Examples, but the present invention is not limited to these Examples, and the present invention can take various aspects as long as the problems of the present invention can be solved.

### EXAMPLES

### 1. Evaluation Test of Breaking Strength and Brix Value of Cooked Pasta (Cream-Based Pasta) Depending on Dextrin Amount

### 1-1. Preparation of Cooked Pasta [1-1]

Commercially available frozen boiled fresh pasta “Fresh Pasta Fettuccine (56% moisture value)” (manufactured by Takara Foods Co., Ltd.) was naturally thawed in its original bag.

Next, the seasoning liquid was prepared by mixing and stirring the raw materials for the seasoning liquid at room temperature (15° C. to 25° C.) according to the amount shown in Table 1 below. 80 g of thawed pasta and 96 g of seasoning liquid, filled into retort bag (manufactured by Toppan Printing Co., Ltd.; material: GL12/DL/ONY15/DL/CPP60), and vacuum degassed before sealing. Then, the cooked pasta [1-1] was prepared by heat and pressure sterilization in the spray retort sterilizer (manufactured by Hisaka Works, Ltd.). The conditions for the heat pressure sterilization treatment were 125° C., maximum pressure of 0.25 MPa, heating for 9 minutes after the temperature in the apparatus reached 125° C., and an F value of 8.5.

TABLE 1

| | | amount |
|---|---|---|
| COOKED PASTA [1-1] | | [% by mass] |
| pasta | frozen boiled fresh pasta | 45.45 |
| | “Fresh Pasta Fettuccine” (manufactured by | |
| | Takara Foods Co., Ltd.) | |
| seasoning | powdered oil/fat (containing milk ingredients) | 15.36 |
| liquid | “Magical Base Milk” (manufactured by | |
| | Miyoshi oil & fat Co., Ltd.) | |
| | dextrin | 2.72 |
| | “Paindex # 1 (DE:8)” (manufactured by | |
| | Matsutani Chemical Industry Co., Ltd.) | |
| | water | 29.83 |
| | tomato paste | 1.60 |
| | “Gold Break” (manufactured by Nile | |
| | international Co., Ltd.) | |
| | reduced starch syrup | 1.06 |
| | salt | 0.80 |
| | garlic powder | 0.15 |
| | black pepper | 0.08 |
| | canola oil | 2.07 |
| | modified starch | 0.43 |
| | glutamic sodium | 0.26 |
| | nucleic acid | 0.04 |
| | parmesan cheese | 0.15 |

| | |
|---|---|
| total | 100.00 |

### 1-2. Preparation of Cooked Pasta [1-2] to [1-7]

As shown in Table 2 below, the cooked pasta [1-2] to [1-7] were prepared in the same manner as in the preparation of cooked pasta [1-1] except that the amount of powdered oil/fat was fixed and the amount of dextrin in the seasoning liquid was 7.50% by mass, 10.00% by mass, 12.50% by mass, 15.00% by mass, 17.50% by mass and 20.00% by mass, respectively, and the amount of water was adjusted so that the total amount of powdered oil/fat, dextrin, and water was 47.91% by mass (overall ratio).

1-3. Preparation of Cooked Pasta [a]

The cooked pasta [a] for comparison was prepared in the same manner as in the preparation of cooked pasta [1-1], except that the dextrin and powdered oil/fat were substituted substituted with water.

### 1-4. Measurement of Breaking Strength

### 1-4-1. Measurement Conditions

The breaking strength of pasta (unit: N (Newton)) was measured using “Rheometer CD-500X” (manufactured by Sun Scientific Co., Ltd. (plunger used; No. 10 (for shearing force)). The measurement was performed 10 times, and the average value was calculated.

### 1-4-2. Measuring Method

The cooked pasta was stored at room temperature (15° C. to 25° C.) for 14 days, then placed in boiling water for 10 minutes and boiled. After boiling, the product was cooled in tap water to 20° C. Pasta was randomly removed immediately after opening the retort bag, cut into 20 mm to 30 mm pieces, and measured for breaking strength. The results are shown in Table 2.

### 1-5. Measurement of Brix Value

### 1-5-1. Measurement Conditions

The Brix value of the sample at a temperature of 20° C. was measured using a hand-held refractometer “MASTER-AH50” (manufactured by AS ONE CORPORATION) as the Brix meter. The measurement was performed 10 times, and the average value was calculated.

In the present invention, in cases where the state of the sample made it impossible to visually check the scale of the hand-held refractometer, measurements were made using the pocket sugar meter “PAL-1” (ATAGO Co., Ltd.) with a digital display.

### 1-5-2. Measuring Method

The Brix value of the seasoning liquid was measured after preparation (before filling the retort bag) at a temperature of 20° C.

For the Brix value of the cooked pasta, the cooked pasta was stored at room temperature (15° C. to 25° C.) for 14 days, then placed in boiling water for 10 minutes and boiled. After boiling, the product was cooled in tap water. All of the seasoning liquid and pasta were removed from the retort bag and stirred in a food processor “DLC-NXJ2SS” (manufactured by Cuisinart) for 2 minutes to make a paste-like sample, and then the Brix value of the sample at a temperature of 20° C. was measured.

The results are shown in Table 2.

### 1-6. Preparation of Normal Cooked Pasta

200 g of frozen boiled fresh pasta “Fresh Pasta Fettuccine (56% moisture value)” (manufactured by Takara Foods Co., Ltd.), which is the same as the pasta used in the preparation of the cooked pasta [1-1], was put into boiling water for 1 minute directly from its frozen state and heat-cooked. 215 g of the cooked pasta after draining was mixed with 70 g of a commercially available pasta sauce “Aeru Pasta Sauce Crab Tomato Cream” (manufactured by Kewpie Corporation), which was boiled for 3 minutes, and then the cooked pasta (hereinafter referred to as “normal cooked pasta”) [A] was prepared. The cooked pasta [A] was allowed to stand until the temperature reached 20° C., and “rheometer CD-500X” (plunger No. 10 (for shear force)) (manufactured by Sun Scientific Co., Ltd) was used to measure the breaking strength in the same manner as described in 1-4-1. In this normal cooked pasta [A], the pasta was allowed to stand until the temperature reached 20° C., all the seasoning liquid and pasta were collected, mixed in the food processor “DLC-NXJ2SS” (manufactured by Cuisinart) for 2 minutes to make a paste-like sample, and then the Brix value of the cooked pasta at a sample temperature of 20° C. was measured. The Brix value of the cooked pasta was measured using the hand-held refractometer “MASTER-AH50” (manufactured by AS ONE CORPORATION) in the same manner as described in 1-5-1. The Brix value of the seasoning liquid was measured using the hand-held refractometer “MASTER-AH50” (manufactured by AS ONE CORPORATION) before mixing with the pasta, under the same measurement conditions as described in 1-5-1. The results are shown in Table 2.

In the present invention, if the breaking strength of the pasta is ±0.2 N of the breaking strength of normal cooked pasta, the pasta has sufficient breaking strength, i.e., the firmness (crunchiness) of the pasta is maintained.

### 1-7. Separation of Seasoning Liquid

For each cooked pasta, the separation of the seasoning liquid was visually checked immediately after opening the retort bag. The results are shown in Table 2.

TABLE 2

| | COOKED PASTA No. | | | | | | | | normal cooked |
|---|---|---|---|---|---|---|---|---|---|
| | [1-1] | [1-2] | [1-3] | [1-4] | [1-5] | [1-6] | [1-7] | [a] | pasta[A] |
| dextrin (overall ratio) (% by mass) | 2.72 | 4.09 | 5.46 | 6.82 | 8.18 | 9.55 | 10.91 | 0.00 | — |
| dextrin (seasoning liquid ratio) | 5.00 | 7.50 | 10.00 | 12.50 | 15.00 | 17.50 | 20.00 | 0.00 | — |
| (% by mass) | | | | | | | | | |
| powdered oil/fat (overall ratio) | 15.36 | | | | | | | 0.00 | — |
| (% by mass) | | | | | | | | | |
| water (overall ratio) (% by mass) | 29.83 | 28.46 | 27.09 | 25.73 | 24.36 | 23.00 | 21.64 | 47.91 | — |
| Brix (seasoning liquid) (%) | 30.0 | 32.5 | 35.0 | 37.5 | 39.5 | 42.5 | 44.5 | 8.0 | 20.0 |
| Brix (cooked pasta) (%) | 33.5 | 36.0 | 37.0 | 38.5 | 39.5 | 41.0 | 42.5 | 22.0 | 35.0 |
| breaking strength (N) | 0.43 | 0.41 | 0.49 | 0.52 | 0.54 | 0.58 | 0.63 | 0.20 | 0.58 |
| separation of seasoning liquid | NO | NO | NO | NO | NO | YES | YES | NO | NO |

### 1-8. Results

As shown in Table 2, the breaking strength of cooked pasta [1-1] to [1-7] tended to increase as the dextrin amount increased. This is thought to be due to the fact that as the dextrin amount increases, the Brix value also increases, resulting in a decrease in free water and overall water transfer, and consequently a decrease in water transfer from the seasoning liquid to the pasta, resulting in a tendency for greater breaking strength.

In all of the cooked pasta [1-1] to [1-7], similar breaking strength was obtained compared to the normal cooked pasta [A]. On the other hand, for the cooked pasta [1-6] and [1-7], the seasoning liquid separated due to excessive dextrin amount.

### 2. Evaluation Test of Breaking Strength and Brix Value of Cooked Pasta (Cream-Based Pasta) Depending on Amount of Powdered Oil/Fat

### 2-1. Preparation of Cooked Pasta [2-1] to [2-5].

As shown in Table 3 below, the cooked pasta [2-1] to [2-5] were prepared in the same manner as in the preparation of cooked pasta [1-1] except that the amount of powdered oil/fat and water in the seasoning liquid was adjusted so that the Brix value of the seasoning liquid was 30.0%, 35.0%, 40.0%, 45.0%, and 50.0%.

### 2-2. Measurement of Breaking Strength

The breaking strength of cooked pasta [2-1] to [2-5] was measured in the same manner as the measurement conditions and method described in 1-4. The results are shown in Table 3.

### 2-3. Measurement of Brix Value

The Brix values of the seasoning liquid and the cooked pasta [2-1] to [2-5] were measured in the same manner as the measurement conditions and methods described in 1-5. Brix value measurement. The results are shown in Table 3.

### 2-4. Separation of Seasoning Liquid

For each cooked pasta, the separation of the seasoning liquid was visually checked immediately after opening the retort bag. The results are shown in Table 3.

TABLE 3

| COOKED PASTA No. | [2-1] | [2-2] | [2-3] | [2-4] | [2-5] |
|---|---|---|---|---|---|
| dextrin (overall ratio) | 6.82 | | | | |
| [% by mass] | | | | | |
| powdered oil/fat (overall ratio) | 10.50 | 14.80 | 17.51 | 19.10 | 21.20 |
| [% by mass] | | | | | |
| water (overall ratio) | 30.59 | 26.29 | 23.58 | 21.99 | 19.89 |
| [% by mass] | | | | | |
| Brix (seasoning liquid) | 30.0 | 35.0 | 40.0 | 45.0 | 50.0 |
| [%] | | | | | |
| Brix (cooked pasta) | 34.0 | 37.5 | 40.5 | 42.5 | 45.5 |
| [%] | | | | | |
| breaking strength [N] | 0.43 | 0.48 | 0.53 | 0.58 | 0.64 |
| separetion of seasoning liquid | NO | NO | NO | NO | NO |

### 2-5. Results

As shown in Table 3, the breaking strength of cooked pasta [2-1] to [2-5] tended to increase as the powdered oil/fat amount increased. This is thought to be due to the fact that as the amount powdered oil/fat increases, as well as the amount of dextrin, the Brix value also increases, resulting in a decrease in free water and overall water transfer, and consequently a decrease in water transfer from the seasoning liquid to the pasta, which would tend to increase the breaking strength. In all of the cooked pasta [2-1] to [2-5], similar breaking strength was obtained compared to the normal cooked pasta [A]. And the seasoning liquid did not separate in any of the cooked pasta [2-1] to [2-5].

### 3. Evaluation Test of Breaking Strength in Cooked Pasta (Cream-Based Pasta) with Fixed Brix Value

### 3-1. Preparation of Cooked Pasta [3-1] to [3-9].

As shown in Table 4 below, the cooked pasta [3-1] to [3-9] were prepared in the same manner as in the preparation of the pre-cooked pasta [1-1] except that the amounts of powdered oil/fat and water in the seasoning liquid were adjusted so that the dextrin amount was adjusted from 1.00% by mass to 20.00% by mass and the Brix value of the seasoning liquid was adjusted to 35.0% (Brix value of the cooked pasta was 37.0% to 38.5%).

### 3-2. Measurement of Breaking Strength

The breaking strength of cooked pasta [3-1] to [3-9] was measured in the same manner as the measurement conditions and method described in 1-4. The results are shown in Table 4.

### 3-3. Separation of Seasoning Liquid

For each cooked pasta, the separation of the seasoning liquid was visually checked immediately after opening the retort bag. The results are shown in Table 4.

TABLE 4

| COOKED PASTA No. | [3-1] | [3-2] | [3-3] | [3-4] | [3-5] | [3-6] | [3-7] | [3-8] | [3-9] |
|---|---|---|---|---|---|---|---|---|---|
| dextrin (overall ratio) | 0.55 | 1.37 | 2.73 | 4.12 | 5.57 | 7.00 | 7.97 | 9.61 | 10.91 |
| (% by mass) | | | | | | | | | |
| dextrin (seasoning liquid ratio) | 1.00 | 2.50 | 5.00 | 7.50 | 10.00 | 12.50 | 15.00 | 17.50 | 20.00 |
| (% by mass) | | | | | | | | | |
| powdered oil/fat (overall ratio) | 19.97 | 19.12 | 18.04 | 16.69 | 15.37 | 13.49 | 10.90 | 9.21 | 7.08 |
| (% by mass) | | | | | | | | | |
| water (overall ratio) | 27.39 | 27.42 | 27.14 | 27.10 | 26.97 | 27.42 | 29.04 | 29.09 | 29.92 |
| (% by mass) | | | | | | | | | |
| Brix (seasoning liquid) | 35.0 | | | | | | | | |
| (%) | | | | | | | | | |
| Brix (cooked pasta) | 38.5 | 38.5 | 38.0 | 37.5 | 37.0 | 37.0 | 37.0 | 37.0 | 37.5 |
| (%) | | | | | | | | | |
| breaking strength (N) | 0.48 | 0.47 | 0.49 | 0.50 | 0.48 | 0.47 | 0.48 | 0.48 | 0.49 |
| separetion of seasoning liquid | NO | NO | NO | NO | NO | NO | NO | YES | YES |

### 3-4. Results

As shown in Table 4, it was found that for cooked pasta [3-1] to [3-9], even if the amount of dextrin and powdered oil/fat varied, if the Brix value was the same, the breaking strength was also the same.

In all of the cooked pastas [3-1] to [3-9], similar breaking strength was obtained compared to the normal cooked pasta [A]. On the other hand, for cooked pasta [3-8] and [3-9], the seasoning liquid separated due to excessive dextrin amount.

### 4. Sensory Test on Cooked Pasta (Cream-Based Pasta)

### 4-1. Test Method

The cooked pasta [3-1] to [3-9] were evaluated by five panels having discriminating ability according to the following evaluation criteria. Table 5 shows the average value of the evaluation points.

### 4-2. Evaluation Criteria

### <Texture>

5: Comparable to normal cooked pasta
4: Good
3: Moderate
2: A little feeling of strangeness
1: A feeling of strangeness

### <Taste>

5: Excellent
4: Delicious
3: No strangeness
2: A little feeling of strangeness
1: A feeling of strangeness

### <Appearance>

5: Excellent
4: Good
3: No strangeness
2: A little feeling of strangeness
1: A feeling of strangeness

TABLE 5

| COOKED PASTA No. | [3-1] | [3-2] | [3-3] | [3-4] | [3-5] | [3-6] | [3-7] | [3-8] | [3-9] |
|---|---|---|---|---|---|---|---|---|---|
| Texture | 3 | 4 | 4 | 4 | 4 | 4 | 4 | 4 | 5 |
| Taste | 2 | 2 | 3 | 4 | 4 | 4 | 4 | 3 | 3 |
| Appearance | 3 | 3 | 4 | 5 | 5 | 4 | 3 | 2 | 2 |
| Average | 2.7 | 3.0 | 3.7 | 4.3 | 4.3 | 4.0 | 3.7 | 3.0 | 3.3 |

### 4-3. Results

As shown in Table 5, the cooked pasta [3-1] to [3-2] were greasy and did not have an excellent taste because of the excessive amount of powdered oil/fat in the seasoning liquid. For the cooked pasta [3-8] to [3-9], the excessive amount of dextrin caused the seasoning liquid to separate, resulting in a poor appearance. On the other hand, cooked pasta [3-3] to [3-7] showed good results in terms of texture, taste and appearance.

### 5. Evaluation Test of Breaking Strength and Brix Value of Cooked Pasta (Tomato-Based Pasta)

### 5-1. Preparation of Cooked Pasta [4]

Commercially available frozen boiled fresh pasta “Fresh Pasta Fettuccine (56% moisture value)” (manufactured by Takara Foods Co., Ltd.) was naturally thawed in the bag.

Next, the seasoning liquid was prepared by mixing and stirring the raw materials for the seasoning liquid at room temperature (15° C. to 25° C.) according to the amount shown in Table 6 below. 80 g of thawed pasta and 96 g of seasoning liquid were weighed, filled into retort bag (manufactured by Toppan Printing Co., Ltd., material: GL12/DL/ONY15/DL/CPP60), and vacuum degassed. Then, cooked pasta [4] was prepared by heat and pressure sterilization in a spray retort sterilizer (manufactured by Hisaka Works, Ltd.). The conditions for the pressure heat sterilization treatment were 125° C., maximum pressure of 0.25 MPa, heating for 9 minutes after the temperature in the apparatus reached 125° C., and an F value of 8.5.

### 5-2. Measurement of Breaking Strength

The breaking strength of cooked pasta [4] was measured in the same manner as the measurement conditions and method described in 1-4. The results are shown in Table 6.

### 5-3. Measurement of Brix Value

The Brix values of the seasoning liquid and the cooked pasta [4] were measured in the same manner as the measurement conditions and method described in 1-5. The results are shown in Table 6.

### 5-4. Separation of Seasoning Liquid

For the cooked pasta [4], the separation of the seasoning liquid was visually checked immediately after opening the retort bag. The results are shown in Table 6.

TABLE 6

| | | amount |
|---|---|---|
| COOKED PASTA [4] | | [% by mass] |
| pasta | frozen boiled fresh pasta | 45.45 |
| | “Fresh Pasta Fettuccine” (manufactured by Co., | |
| | Takara Foods Ltd.) | |
| seasoning | tomato paste | 24.91 |
| liquid | “Gold Break” (manufactured by Nile | |
| | international Co., Ltd.) | |
| | dextrin | 7.02 |
| | “Paindex # 1 (DE:8)” (manufactured by | |
| | Matsutani Chemical Industry Co., Ltd.) | |
| | olive oil (manufactured by Sanyo Foods | 9.73 |
| | Industry Co., Ltd.) | |
| | salt | 1.29 |
| | water | 12.00 |

| | |
|---|---|
| total | 100.00 |
| Brix (seasoning liquid) [%] | 35.0 |
| Brix (cooked pasta) [%] | 38.0 |
| breaking strength [N] | 0.49 |
| separetion of seasoning liquid | NO |

### 5-5. Results

The results of Table 6 show that for cooked pasta [4], in spite of tomato-based pasta other than cream-based pasta, sufficient breaking strength can be obtained if the Brix value of the cooked pasta is between 33.5% and 45.5%.

The above results, from Tables 2 to 6, show that if the dextrin is contained at the ratio of 1.0% by mass to 15.0% by mass and the Brix value of the cooked pasta is 33.5% to 45.5%, the separation of the seasoning liquid is suppressed, and the breaking strength is equivalent to that of normal cooked pasta. It was also found that if the Brix value of the cooked pasta is between 33.5% and 45.5%, then in addition to the dextrin, any of the soluble solid ingredients such as oils/fats, dairy products, and processed tomato products can be used as ingredients to adjust the Brix value, and still produce the breaking strength equivalent to that of normal cooked pasta.

### 6. Evaluation Test of Breaking Strength and Brix Value of Cooked Pasta (Short Pasta)

### 6-1. Preparation of Cooked Pasta [5]

Commercially available dried macaroni “MA-MA MAKARONI (moisture value 12%)” (manufactured by Nissin Foods Co., Ltd.) was heat-treated in boiling water for 10 minutes (yield 163%, moisture value 46%).

Next, the seasoning liquid was prepared by mixing and stirring the raw materials for the seasoning liquid at room temperature (15° C. to 25° C.) according to the amount shown in Table 7 below. 70 g of heat-treated pasta (macaroni) and 130 g of seasoning liquid were weighed, filled into retort bag (manufactured by Toppan Printing Co., Ltd.; material: GL12/DL/ONY15/DL/CPP60), and vacuum degassed. Then, cooked pasta [5] was prepared by heat and pressure sterilization in a spray retort sterilizer (manufactured by Hisaka Works, Ltd.). The conditions for the pressure heat sterilization treatment were 125° C., maximum pressure of 0.25 MPa, heating for 9 minutes after the temperature in the apparatus reached 125° C., and an F value of 8.5.

TABLE 7

| | | amount |
|---|---|---|
| COOKED PASTA [5] | | [% by mass] |
| pasta | macaroni | 35.00 |
| | “MA-MA MAKARONI” (manufactured by | |
| | Nissin Foods Co., Ltd.) | |
| seasoning | cheeze source | 24.37 |
| liquid | “TOROKERU CHEEZE SOFT”(manufactured | |
| | by HOKO Co., Ltd.) | |
| | powdered oil/fat (containing milk ingredients) | 7.05 |
| | “Magical Base Milk” (manufactured by | |
| | Miyoshi oil & fat Co., Ltd.) | |
| | dextrin | 6.96 |
| | “Paindex # 1 (DE:8)” (manufactured | |
| | by Matsutani Chemical Industry Co., Ltd.) | |
| | water | 23.35 |
| | butter | 2.29 |
| | salt | 0.57 |
| | black pepper | 0.19 |
| | glutamic sodium | 0.15 |
| | nucleic acid | 0.07 |

| | |
|---|---|
| total | 100.00 |

6-2. Preparation of Cooked Pasta [b]

The cooked pasta [b] for comparison was prepared in the same manner as in 1-1. the preparation of cooked pasta [5], except that the dextrin and powdered oil/fat were substituted substituted with water.

### 6-3. Measurement of Breaking Strength

The breaking strengths of cooked pasta [5] and [b] were measured in the same manner as the measurement conditions and methods described in 1-4. The results are shown in Table 8.

### 6-4. Measurement of Brix Value

The Brix values of the seasoning liquid and cooked pasta were measured for cooked pasta [5] and [b] in the same manner as the measurement conditions and methods described in 1-5. The results are shown in Table 8.

### 6-5. Preparation of Normal Cooked Pasta

The normal cooked pasta [B] was produced as follows: 70 g of dried macaroni “MA·MA MAKARONI (moisture value 12%)” (manufactured by Nissin Foods Inc.), which is the same as the pasta (macaroni) used in 6-1. Preparation of cooked pasta [5] as above was heated in boiling water for 10 minutes, and 166 g of the boiled macaroni (moisture value 63%) was mixed with 70 g of commercially available pasta sauce “Aeru Pasta Sauce Crab Tomato Cream” (manufactured by Kewpie Corporation) that had been boiled in water for 3 minutes. In this normal cooked pasta [B], the pasta was allowed to stand until the temperature reached 20° C., and “rheometer CD-500X” (plunger No. 10 (for shearing force)) manufactured by Sun Scientific Co., Ltd. was used to measure the breaking strength of the pasta in the same manner as the measurement conditions described in 1-4-1. In this normal cooked pasta [B], the pasta was allowed to stand until the temperature reached 20° C., all the liquid and pasta were collected, stirred in the food processor “DLC-NXJ2SS” (manufactured by Cuisinart) for 2 minutes to make a paste-like sample. The Brix value of the pasta was measured using the hand-held refractometer “MASTER-AH50” (manufactured by AS ONE CORPORATION) in the same manner as the measurement conditions described in 1-5-1. The Brix value of the seasoning liquid was measured using the hand-held refractometer “MASTER-AH50” (manufactured by AS ONE CORPORATION) before mixing with the pasta, under the same measurement conditions as described in 1-5-1. The results are shown in Table 8.

TABLE 8

| COOKED PASTA No. | [5] | [b] | normal cooked pasta[B] |
|---|---|---|---|
| Brix (seasoning liquid) | 32.0 | 15.0 | 20.0 |
| [%] | | | |
| Brix (cooked pasta) | 38.0 | 26.0 | 30.5 |
| [%] | | | |
| breaking strength [N] | 0.96 | 0.44 | 1.14 |

### 6-6. Results

The results in Table 8 show that even if the pasta is short pasta, the Brix value of the cooked pasta is between 33.5% and 45.5%. It was found that sufficient breaking strength could be obtained.

The results in Tables 1-8 show that if the seasoning liquid contains the dextrin at a ratio of 1.0% by mass to 15.0% by mass and the soluble solid ingredient, and the resulting cooked pasta has the Brix value of 33.5% to 45.5%, separation of the seasoning liquid is suppressed regardless of the type of pasta or seasoning liquid, The firmness (crunchiness) of the pasta was maintained even after long-term storage.

### 7. Evaluation Test of Breaking Strength of Cooked Pasta by Over Time

7-1. Preparation of Cooked Pasta [i].

The seasoning liquid was prepared by mixing and stirring the ingredients for the seasoning liquid at room temperature (15° C. to 25° C.) according to the amounts shown in Table 9 below.

Commercially available frozen boiled fresh pasta “Fresh Pasta Fettuccine (moisture value 56%)” (manufactured by Takara Foods Co., Ltd.) in frozen state was heated in boiling water for 1 minute and then drained.

The cooked pasta [i] was prepared by weighing 218 g of hot water-drained pasta and 240 g of seasoning liquid before mixing.

TABLE 9

| | | amount |
|---|---|---|
| COOKED PASTA [i] | | [% by mass] |
| pasta | frozen boiled fresh pasta | 45.45 |
| | “Fresh Pasta Fettuccine” (manufactured by | |
| | Takara Foods Co., Ltd.) | |
| seasoning | powdered oil/fat (containing milk ingredients) | 15.36 |
| liquid | “Magical Base Milk” (manufactured by | |
| | Miyoshi oil & fat Co., Ltd.) | |
| | dextrin | 6.82 |
| | “Paindex # 1 (DE:8)” (manufactured by | |
| | Matsutani Chemical Industry Co., Ltd.) | |
| | water | 25.73 |
| | tomato paste | 1.60 |
| | “Gold Break” (manufactured by Nile | |
| | international Co., Ltd.) | |
| | reduced starch syrup | 1.06 |
| | salt | 0.80 |
| | garlic powder | 0.15 |
| | black pepper | 0.08 |
| | canola oil | 2.07 |
| | modified starch | 0.43 |
| | glutamic sodium | 0.26 |
| | nucleic acid | 0.04 |
| | parmesan cheese | 0.15 |

| | |
|---|---|
| total | 100.00 |

### 7-2. Preparation of Pre-Cooked Pasta [C]

Frozen boiled fresh pasta “Fresh Pasta Fettuccine (moisture value 56%)” (manufactured by Takara Foods Co., Ltd.) put into boiling water for 1 minute in its frozen state and heat-cooked and then drained.

The normal cooked pasta [C] was prepared by weighing 222 g of hot water-drained pasta and 70 g of a commercial pasta sauce “Aeru Pasta Sauce Crab Tomato Cream” (made by Kewpie Corporation) that was boiled in hot water for 3 minutes, then mixed together.

### 7-3. Measurement of Breaking Strength

The breaking strengths of cooked pasta [i] and normal cooked pasta [C] were measured immediately after preparation, after 15 minutes, after 30 minutes, and after 45 minutes, in the same manner as the measurement conditions described in 1-4-1. The results are shown in Table 10. The breaking strength of cooked pasta [1-4] was also measured immediately after boiling in hot water, after 15 minutes, after 30 minutes, and after 45 minutes, as well as for reference.

### 7-4. Measurement of Brix Value

The Brix values of the seasoning liquid and cooked pasta were measured for cooked pasta [i] and normal cooked pasta [C] under the same measurement conditions described in 1-5-1. The results are shown in Table 10.

For the cooked pasta, the cooked pasta was divided into four equal portions, and each divided pasta and seasoning liquid were mixed at each time point in the food processor “DLC-NXJ2SS” (manufactured by Cuisinart) for 2 minutes to make a paste-like sample, and then the Brix value was measured.

TABLE 10

| | Brix | Brix | | | | |
|---|---|---|---|---|---|---|
| | (seasoning | (cooked | breaking strength (N) | | | |
| | liquid) | pasta) | immediately | 15 minutes | 30 minutes | 45 minutes |
| | (%) | (%) | after | after | after | after |
| cooked pasta [i] | 37.5 | 38.0 | 0.73 | 0.73 | 0.69 | 0.69 |
| normal cooked pasta [C] | 20.0 | 32.5 | 0.77 | 0.60 | 0.58 | 0.49 |
| cooked pasta [1-4] | 37.5 | 38.5 | 0.52 | 0.52 | 0.54 | 0.53 |

### 7-5. Results

The results in Table 10 show that sufficient breaking strength was obtained for the cooked pasta [i] and [1-4], even after 45 minutes.

The results in Tables 1-10 show that if the Brix value of the resulting cooked pasta is between 33.5% and 45.5%, the pasta maintains its firmness (crunchiness) not only after long-term storage but also after a certain amount of time has elapsed during eating.

### Industrial Applicability

The cooked pasta cooked pasta according to one embodiment of the present invention suppresses separation of the seasoning liquid and maintains the firmness (crunchiness) of the pasta, thus adding value as a new processed food.

1. A cooked pasta comprising a seasoning liquid and pasta,
wherein the seasoning liquid contains dextrin at a ratio of 1.0% by mass to 15.0% by mass and a soluble solid ingredient, and
a Brix value of the cooked pasta is 33.5% to 45.5%.

2. The cooked pasta according to claim 1, wherein the soluble solid ingredient is at least one of an oil, a dairy product and a processed tomato product.

3. The cooked pasta according to claim 1, wherein the seasoning liquid is contained at a ratio of 80 parts by mass to 200 parts by mass with respect to 100 parts by mass of the pasta.

4. The cooked pasta according to claim 1, wherein the cooked pasta is packed in a retort container.

5. A method of producing a cooked pasta, comprising;
a step of obtaining the cooked pasta by mixing pasta with a seasoning liquid containing dextrin at a ratio of 1.0% by mass to 15.0% by mass and a soluble solid ingredient, and
wherein the cooked pasta has a Brix value of 33.5% to 45.5%.

6. The method according to claim 5, wherein the soluble solid ingredient is at least one of an oil, a dairy product and a processed tomato product.

7. The method according to claim 5, wherein the seasoning liquid is contained at a ratio of 80 part by mass to 200 parts by mass with respect to 100 parts by mass of the pasta.

8. A seasoning liquid for pasta comprising dextrin at a ratio of 1.0% by mass to 15.0% by mass and a soluble solid ingredient,
wherein the seasoning liquid has a Brix value of 30.0% to 50.0%.

9. The seasoning liquid according to claim 8, wherein the soluble solid ingredient is at least one of an oil, a dairy product and a processed tomato product.
